(19) United States
(12) Patent Application Publication
(10) Pub. No.: US 2021/0284336 A1
(43) Pub. Date: Sep. 16, 2021

(54) HOVERING DEVICE FOR LAND SURVEYING

(71) Applicant: CIVDRONE LTD., Tel Aviv (IL)

(72) Inventors: Liav MULER, Tel Aviv (IL); Tom YESHURUN, Tel Aviv (IL)

(73) Assignee: CIVDRONE LTD., Tel Aviv (IL)

(21) Appl. No.: 17/260,255

(22) PCT Filed: Jul. 23, 2019
(86) PCT No.: PCT/IL2019/050836

§ 371 Date: Jan. 14, 2021

Related U.S. Application Data
(60) Provisional application No. 62/715,302, filed on Aug. 7, 2018.

(51) Int. Cl. B64C 39/02; H04N 7/18; B64D 1/02; B64D 47/02

(52) U.S. Cl. CPC B64C 39/024; H04N 7/185; B64C 2201/127; B64D 47/02; B64C 2201/128; B64D 1/02

(57) ABSTRACT

Disclosed herein is a hovering device for land marking. The hovering device may include: a hovering unit, a position detector attached to the hovering unit; at least one marker application unit carried by the hovering unit; at least one markers container, carried by the hovering unit, for feeding one or more markers to the at least one marker application unit; and a controller configured to: receive a location in an area to be marked by a marker; direct the hovering unit to hover over the location based on information received from the position detector; and control the at least one marker application unit to apply a marker to the location.

### TECHNICAL FILED OF THE INVENTION

The invention is related to the field of land surveying and more precisely to the field of land stakeout for land surveying.

### BACKGROUND OF THE INVENTION

Conducting land survey in modern days construction sites includes stakeout hundreds and even thousands of points every day. Continuous land survey is conducted regularly during the entire construction phase, in particular during infrastructure constructions, such as, roads, bridges and the like. The land stakeout is conducted manually by a team of at least two workers with an average output of approximately 120 points per day per team. This undigitized process, which includes many stages, is exposed to human error which lead to inaccurate execution of plans/blueprints, and may require reworks, as well as hazards in the construction site and injury due to inaccurate marking and missing information.

Accordingly, there is a need for an automated system that can travel easily in any construction site, for example, by hovering over the site and mark locations indicated by a computerized system.

### SUMMARY OF THE INVENTION

Some aspects of the invention may be directed to a hovering device for land marking. The hovering device may include: a hovering unit, a position detector attached to the hovering unit; at least one marker application unit carried by the hovering unit; at least one markers container, carried by the hovering unit, for feeding one or more markers to the at least one marker application unit; and a controller configured to: receive a location in an area to be marked by a marker; direct the hovering unit to hover over the location based on information received from the position detector; and control the at least one marker application unit to apply a marker to the location.

In some embodiments, the at least one marker application unit may include a dispatching mechanism for dispatching markers from the position of hovering device in the air towards the location in the area. In some embodiments, the at least one marker application unit may include a screwing device configured to screw a marker to the location while the hovering device hovers above the location. In some embodiments, the controller may further be configured to land the hovering device at the location and control the marker application unit to mark the location thereafter. In some embodiments, the controller may further be configured to control the at least one marker application unit to apply the marker at a deviation of no more than 10 cm from the location.

In some embodiments, the one or more markers may be selected from a group consisting of: arrows, screws, bolts, wedges, stakes, pegs, spits, pin, skewers, flags, nails, stickers, three-dimensional printed element and engraving. In some embodiments, the one or more marking units may be selected from a group consisting of: a laser pointer, a spraying device, a color painter and a sticker. In some embodiments, the position detector may be at least one of: a real time kinematics (RTK) detector with a GPS, GNSS system, based of a 3D model of the area, robotic total station, based on ground control points and based on beacons spread around the area.

In some embodiments, the hovering device may further include a camera attached to the hovering unit for capturing one or more images of at least a portion of the area. In some embodiments, the controller may further be configured to: receive an image of the area from the camera; and control the at least one marker application unit to apply a marker to the location also based on data extracted from the received image.

Some additional aspects of the invention may be directed to a hovering system that includes a first hovering device and a second hovering device. In some embodiments, the first hovering device may include a first hovering unit; a position detector; and a first marker application unit for applying a first marker. In some embodiments, the second hovering device may include a second hovering unit; at least one second marker application unit carried by the second hovering unit; at least one markers container, carried by the second hovering unit, for feeding one or more markers to the at least one second markers application unit; and a detector for detecting a first marker made by the first marker application unit of the first hovering device. In some embodiments the system may further include at least one controller configured to: receive a location in an area to be marked by a marker; direct the first hovering unit to hover over or near the location based on information received from the position detector; control the first marker application unit to applying the first marker; direct the second hovering unit to hover over the location based the first marker detected by the detector; and control the at least one second marker application unit to apply a second marker to the location marked by the first marking.

In some embodiments, the first marker application unit may be selected from a group consisting of: a laser pointer, a spraying device and a color painter. In some embodiments, the at least one second marker application unit may include dispatching mechanism for dispatching markers from the position of hovering device in the air towards the location in the area. In some embodiments, the at least second one marker application unit may include a screwing device configured to screw a marker to the location while the hovering device hovers above the location. In some embodiments, the at least one controller may further be configured to land the second hovering device at the location and control the second marker application unit to mark the location thereafter.

### BRIEF DESCRIPTION OF TRE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a hovering device for land marking according to some embodiments of the invention;

FIG. 2A is an illustration of a hovering device for land marking according to some embodiments of the invention;

FIGS. 2B and 2C are illustrations of markers to be used in the hovering device of FIG. 2A according to some embodiments of the invention;

FIGS. 3-5 are illustrations of hovering devices for marking using a screw according to some embodiments of the invention;

FIG. 6 is an illustration of a hovering device for land marking according to some embodiments of the invention;

FIG. 7A is an illustration of a hovering device for land marking according to some embodiments of the invention;

FIGS. 7B-7D are illustrations of markers to be used in the hovering device of FIG. 7A according to some embodiments of the invention;

FIG. 8A is an illustration of a hovering device for land marking according to some embodiments of the invention;

FIG. 8B is an illustration of a marker to be used in the hovering device of FIG. 8A according to some embodiments of the invention;

FIG. 9A is an illustration of a hovering device for land marking according to some embodiments of the invention;

FIG. 9B is an illustration of a marker to be used in the hovering device of FIG. 9A according to some embodiments of the invention;

FIG. 10A is an illustration of a hovering device for land marking according to some embodiments of the invention;

FIG. 10B is an illustration of a marker to be used in the hovering device of g. 10A according to some embodiments of the invention;

FIG. 11-12 are illustration of hovering devices for land marking according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Aspects of the invention may be directed to a hovering device, such as a drone, that carries a markers application unit and is configured to mark a location in construction sites, either from the air or by landing near the location or above it.

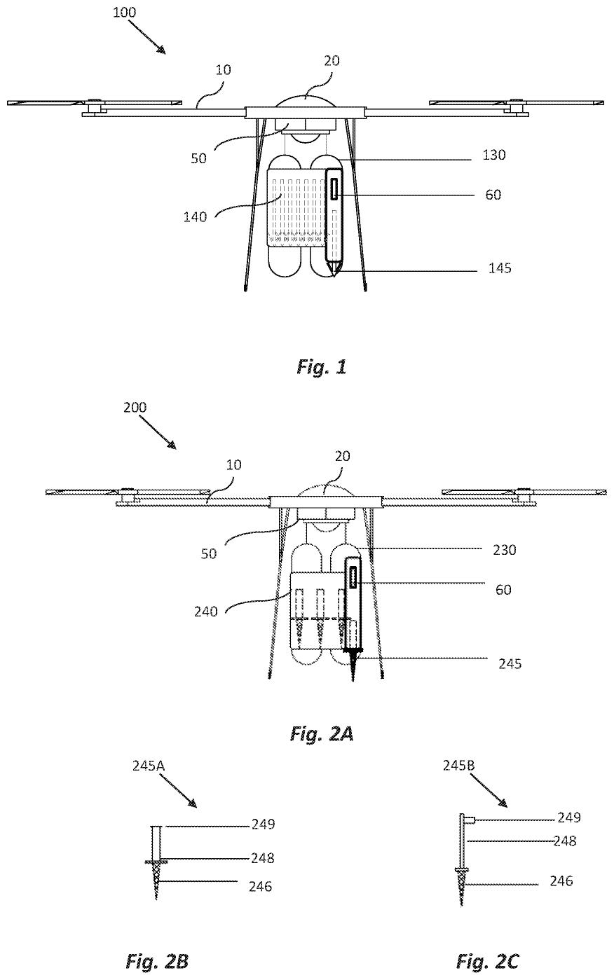

Reference is now made to FIG. 1 which is an illustration of a hovering device for land marking according to some embodiments of the invention. Hovering device 100 may include a hovering unit 10, a position detector 20 attached to hovering unit 10, at least one marker application unit 130 carried by hovering unit 10 and at least one markers container 140, carried by hovering unit 10, for feeding one or more markers 145 or a material that produces one or more markers 145 to at least one marker application unit 130. In some embodiments, markers container 140 may be any magazine, cartridge, and the like that is configured to feed markers or markers container 140 may be a tank that is configured to feed material to be deposited as a marker. Hovering device 100 may further include a controller 50, for controlling various elements of device 100 and a camera 60 for capturing images of the area.

In some embodiments, controller 50 may include a processor, a memory for storing thereon instructions, and a wireless communication unit for communication with external processors/computers. In some embodiments, controller 50 may be configured to receive a location in an area to be marked by marker 145 and direct hovering unit 10 to hover over the location based on information received from position detector 20. In some embodiments, controller 50 may control at least one marker application unit 130 to apply marker 145 to the location.

In some embodiments, hovering unit 10 may include any device that can hover above a location at relative stability in the air which allow marking, for example, a movement of at most 10 cm (e.g., sideways or up/down) during the marking process. For example, hovering unit 10 may be a drone or any other unmanned aerial vehicle configured to hover. In some embodiments, the total weight of hovering unit 10 and/or hovering device 100 may be 6-80 kg. In some embodiments, hovering unit 10 may be operated automatically and may be controlled by controller 50. In some embodiments, hovering unit 10 may be operated semi-automatically also by a human operator using a remote control.

In some embodiments, position detector 20 may be or may include any device/system or unit that is configured to detect a location in the area based on information and/or signals received. For example, position detector 20 may be: a real time kinematics (RTK) detector with a GPS, position detector 20 may detect the location based on a 3D model of the area, photo analysis, position detector 20 may detect the location based on ground control points, position detector 20 may detect the location based on beacons spread around the area and the like. In some embodiments, positioning detector 20 may be a robotic total station, which is configured to guide hovering unit 10 either while in the air or after landing. After landing the robotic total station may know with high accuracy (in a 1-2 mm accuracy) where, hovering unit 10 landed by measuring its prism which is fixed. Accordingly, the robotic total station may guide at least one marker application unit 130 to mark to apply markers at the location high accuracy.

In some embodiments, controller 50 may be configured to control the at least one marker application unit to apply the marker at a deviation of no more than 10 cm from the location, for example, no more than, 8, 6, 5, 4, 3 cm while hovering device 100 is hovering over the location. Such a high accuracy may be achieved using more than one position detectors 20 or by combining the detection from position detector 20 with a location calculated from image analysis of an image of at least a portion of the area taken by camera 60 and optionally additional prestored image data. In some embodiments, in order to further increase the accuracy of the marking to 1-2 cm, controller 50 may control the hovering device to land at/near the location and to mark the location after landing.

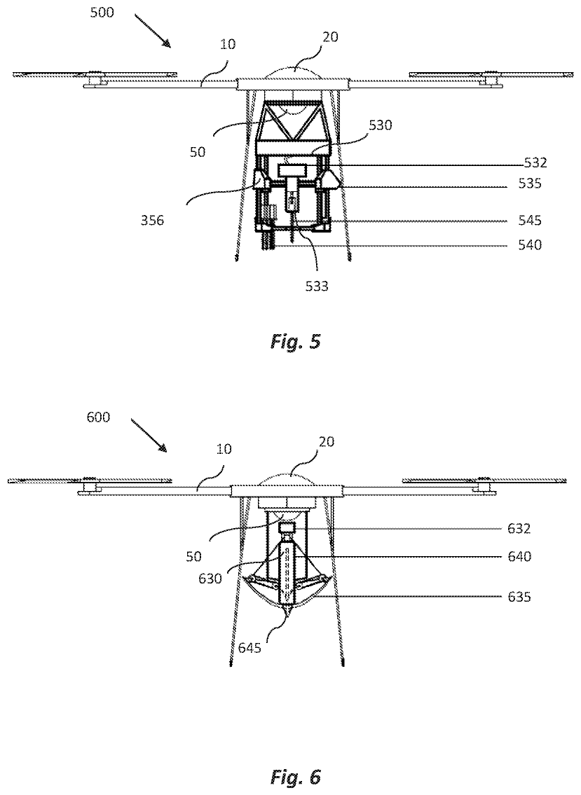

In some embodiments, at least one marker application unit 130 may be any unit/device that is configured to apply markers at a location. Various marker application is units are disclosed as examples at FIGS. 2-12. In some embodiments, at least some marker application units may be mechanical units. In some embodiments, the at least one marker application unit may include a dispatching mechanism 230-1230 for dispatching markers from the position of hovering device in the air towards the location in the area. In some embodiments, the dispatching mechanism may be configured to mechanically dispatch rigid three-dimensional (3D) markers, such as pegs. For example, marker application unit 130, illustrated in FIG. 1 may include gas tanks that are configured to provide pressurized gas in order to dispatch marker (e.g., peg) 145 towards the location in the area, for example, while hovering device 100 hovers over the location. In some embodiments, marker application unit 130 may be configured to apply marker 145 after landing. In some embodiments, controller 50 may be configured to land hovering device 100 at the location and control marker application unit 130 to mark the location thereafter.

In some embodiments, at least one markers container 140 may be any container that is configured to feed one or more markers 145 to at least one marker application unit 130. Several examples for markers container are illustrated and discussed with respect to FIGS. 2-12. For example, markers container 140 may be configured to feed a dispatch marker (e.g., peg) 145 to the dispatching markers application unit 130. In some embodiments, each marker container may be configured to carry at least 50 markers.

In some embodiments, markers, such as marker 145 may be rigid 3D elements that are configured to be stuck (e.g., at least partially inserted) in the ground at the location, for example, a first portion of the marker may be inserted 5-10 cm. in the ground and a second portion may extend 10-50 cm. (e.g., 30 cm.) from the ground. In some embodiments, the markers may be selected from a group consisting of: arrows, screws, bolts, wedges, stakes, pegs, spits, pins, skewers, flags, nails, stickers, 3d printed elements, engravings and the like. The markers may be made from any suitable materials, for example, alloys (e.g., steel), harden wood and the like. In some embodiments, the material or materials included in the marker and the design of the marker may be selected according to the type of land (e.g., sandy, rocky, concrete, asphalt, gravel, clay, red soil, aggregate baes course and the like) in the area. In some embodiments, markers, such as marker 145 may be selected from a group consisting of: epoxy, glue, ink, a laser point and the like, as to form a printed/sprayed/pointed/sticker/marker in the location.

Reference is now made to FIG. 2A which is an illustration of a hovering device for land marking according to some embodiments of the invention. Hovering device 200 may include: hovering unit 10, position detector 20, controller 50 and camera 60, as discloses hereinabove with respect to hovering device 100. In some embodiments, hovering device 200 may further include at least one marker application unit 230 that may include one or more pressurized gas tanks configured to dispatch one or more markers (e.g., peg) 245 using the driving force of the gas. Pegs 245 may be stored in container 240 to be feed into marker application unit 230.

In some embodiments, markers 245 may include a machine-readable element, such as an MID, a barcode, a QR code, a numerical code and the like, to be read by a compatible reader (e.g., an RFID reader, a QR code reader etc.). Each machine readable element may include an ID number/code and controller 50, or an external processor may associate the ID number/code of the marker with the location of the marker. Some examples for such markers are illustrated in FIGS. 2B and 2C. Pegs 245A and 245B include insertion heads 246, pegs body 248 and machine-readable element 249.

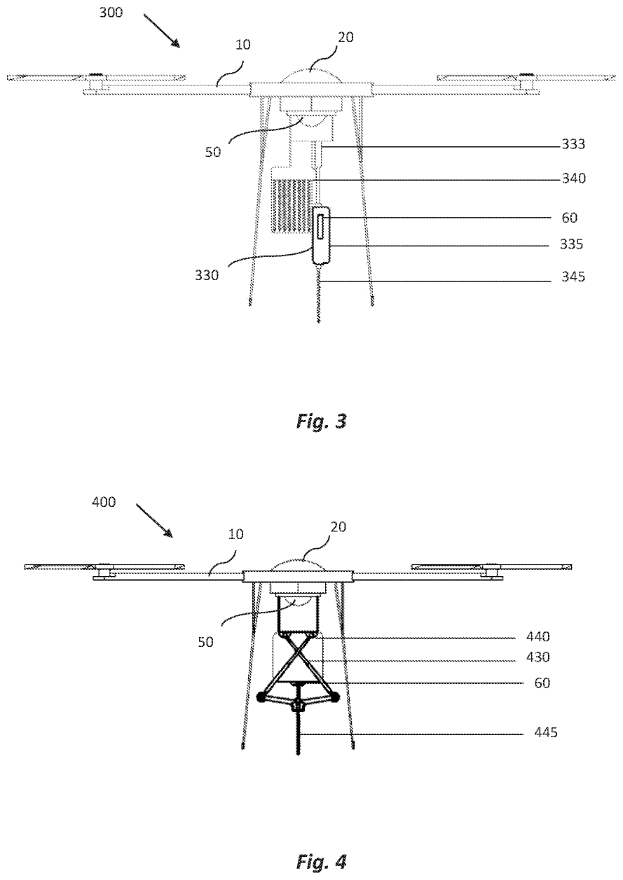

Reference is now made to FIGS. 3, 4 and 5 which are illustrations of hovering devices using a screw marker, according to some embodiments. Hovering devices 300, 400 and 500 may each include hovering unit 10, position detector 20, controller 50 and camera 60, as discloses hereinabove, with respect to hovering device 100. In some embodiments, controller 50 of each of hovering devices 300, 400 and 500 may control each device to land at the location and mark the location thereafter.

In some embodiments, hovering device 300 may further include at least one marker application unit 330 and at least one markers container 340. Marker application unit 330 may be a screwing device and may include a piston 333 (e.g., hydraulic piston, a pneumatic piston and the like) and a driller (e.g., borer, bit, auger, gimlet, jackhammer, wimble, etc.) 335 for drilling markers 345 into the ground. In some embodiments, markers 345 may be a self-drilling screw that may be stored in container 340 to be fed into marker application unit 330.

In some embodiments, hovering device 400 may include at least one marker application unit 430 and at least one markers container 440. Marker application unit 430 may be a screwing device and may include two pistons configured to provide an angular moment to marker 445, being a self-drilling screw that may be stored in container 440.

In some embodiments, hovering device 500 may further include at least one marker application unit 530 and at least one markers container 540. Marker application unit 530 may be a screwing device and may include a motor 532 (e.g., an electric motor) that powers an axles unit 535 to drill a self-drilling marker 545 (e.g., a self-drilling screw) to the location. A plurality of self-drilling screws 545 may be stored in container 540.

In some embodiments, at least one marker application unit 530 may include two or more devices, for example, a hole making (e.g., drilling) device 533 powered by motor 532 for making holes at the location and a screwing device 536 for screwing marker 545 (not being a self-drilling marker) into the hole made by hole making device 533. In some embodiments, motor 532 may power an axles unit 537 to move hole making device 533 at at least one axis, for example, the vertical axe and make holes. In some embodiments, motor 532 may power an axles unit 535 to place screwing device 536 over the hole and screw marker 545 into the hole, thus to move at 3 axes.

In some embodiments, a hole making (e.g., drilling) device 533 may be included in any one of the embodiments the marker application units and the hovering devices disclosed herein. In such cases, hole making device 533 may make a hole at the location prior to the insertion of any physical marker.

Reference is now made to FIG. 6 which is an illustration of a hovering device for land marking according to some embodiments of the invention. Hovering device 600 may include: hovering unit 10, position detector 20, controller 50 and camera 60, as discloses herein above with respect to hovering device 100. In some embodiments, hovering device 600 may further include at least one marker application unit 630 and at least one markers container 640. Marker application unit 630 may include a dispatching mechanism comprising a motor 632 and a bow 635 for dispatching a marker 645 (e.g., a tack, an arrow and the like) to the location. Tacks 645 may be stored in container 640.

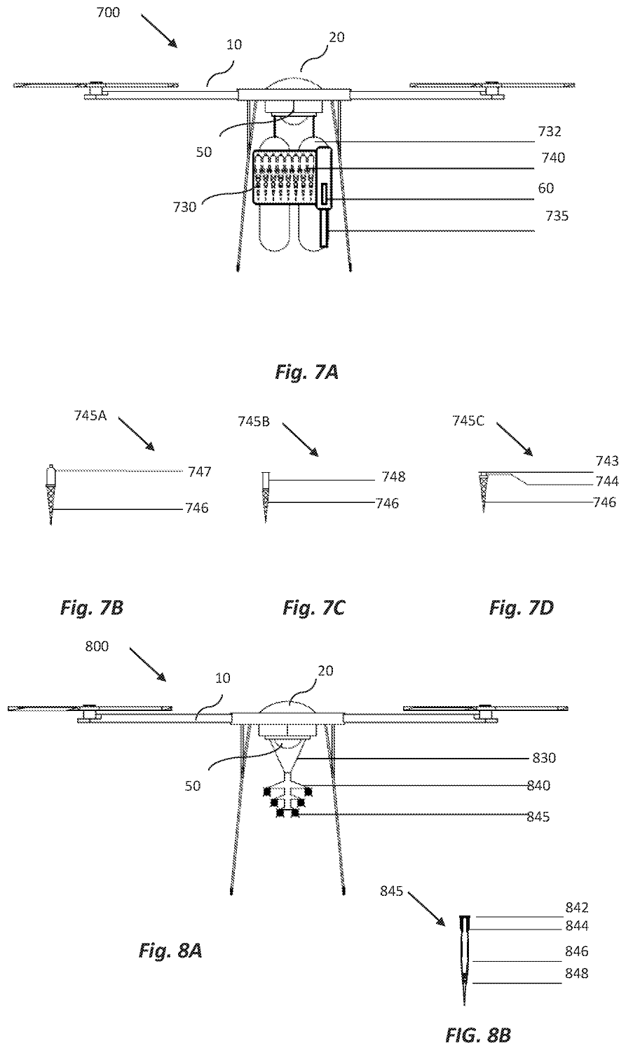

Reference is made to FIG. 7A which is an illustration of a hovering device for land marking according to some embodiments of the invention. Hovering device 700 may include: hovering unit 10, position detector 20, controller 50 and camera 60, as discloses herein above with respect to hovering device 100. In some embodiments, hovering device 700 may further include at least one marker application unit 730 and at least one markers container 740. Marker application unit 730 may include a dispatching mechanism that includes one or more pressurized gas thanks that provide gas to a shooting/′insertion unit 735 that is configured to shoot (e.g., dispatch) a marker (e.g., markers 745A-745C illustrated in FIGS. 7B-7D). The markers may be stored in container 740 and may be fed to shooting/insertion unit 735 upon request, form controller 50.

In some embodiments, the markers may include explosive/expanding materials and/or elements that provide an additional momentum to the marker, as disclosed herein below. Reference is now made to FIGS. 7B, 7C and 7D which are illustrations of markers for use in the hovering device of FIG. 7A according to some embodiments. Marker 754A, illustrated in FIG. 7B, may include an insertion head 746 and a condensed polymeric material, for example, polyurethane chemical compound, fast drying plastic polymers, quick curing polymers and the like, that is configured to be condensed inside container 740 and extend upon dispatching. Marker 754B, illustrated in FIG. 7C, may include insertion head 746 and a gun-powder cartridge 748 that is configured to explode prior to dispatching from shooting unit 735. Marker 745C, illustrated in FIG. 7D, may include insertion head 746 and a magnet 744. In some embodiments, magnet 744 may also be utilized for extension of the stake. The magnet is configured to be closely packed inside container 740. Insertion unit 735 may have an additional magnet at its upper wall having the same pole as of the surface of magnet 744 facing insertion unit 735. Accordingly, upon dispatching from insertion unit 735 marker 745C may be drawn away from insertion unit 735 due to magnetic rejection forces. In some embodiments, marker 745C may further include a machine readable element 743, as discussed hereinabove.

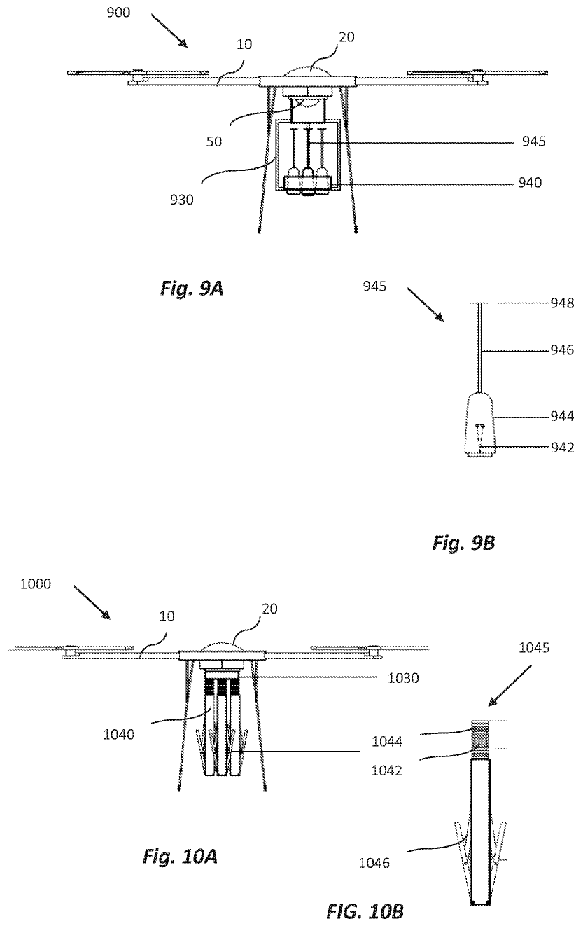

Reference is made to FIG. 8A which is an illustration of a hovering device for land marking according to some embodiments of the invention. Hovering device 800 may include: hovering unit 10, position detector 20, controller 50 and camera 60, as discloses hereinabove with respect to hovering device 100. In some embodiments, hovering device 800 may further include at least one marker application unit 830 and at least one markers container 840. Marker application unit 830 may include a dispatching mechanism that is configured to release a marker 845 while hovering unit 10 is flying towards the location at lit a known speed. In some embodiments, controller 50 may calculate the exact time for marker application unit 830 to release marker 845 such that marker 845 may fly and stuck at the location. For that to happened marker 845 may have an aerodynamics shape that includes a weight 848 at the front end for causing marker 845 to turn in the air and stuck in the location. Weight 848 may be made from any heavy alloy, such as tungsten alloys. In some embodiments, marker 845 may further include a body 846 and machine readable elements 842 and 844. Reference is made to FIG. 9A which is an illustration of a hovering device for land marking according to some embodiments of the invention. Hovering device 900 may include: hovering unit 10, position detector 20, controller 50 and camera 60, as discloses herein above with respect to hovering device 100. In some embodiments, hovering device 900 may further include at least one marker application unit 930 and at least one markers container 940. Marker application unit 930 may include a dispatching mechanism for releasing a marker 945 directly above the location. In some embodiments, upon hitting the ground an explosive material held in cartridge 944 may explode and cause tack 942 to be stuck in the ground. In some embodiments, marker 945 may further include a stake 946 and a machine readable element 948, as discloses herein.

Reference is made to FIG. 10A which is an illustration of a hovering device for land marking according to some embodiments of the invention. Hovering device 1000 may include: hovering unit 10, position detector 20, controller 50 and camera 60, as discloses herein above with respect to hovering device 100. In some embodiments, hovering device 1000 may further include at least one marker application unit 1030 and at least one markers container 1040. Marker application unit 1030 may include a dispatching mechanism for dispatching cocked peg markers 1045 in the form of cocked pegs from container 1040. Cocked peg marker 1045, illustrated in FIG. 10B, may include, a cocked stabilizing system 1046 and a peg body 1042. Cocked stabilizing system 1046 is configured to deploy and stabilize peg body 1042 at the location. In some embodiments, cocked peg marker 1045 may further include a machine-readable element 1044, as discussed hereinabove.

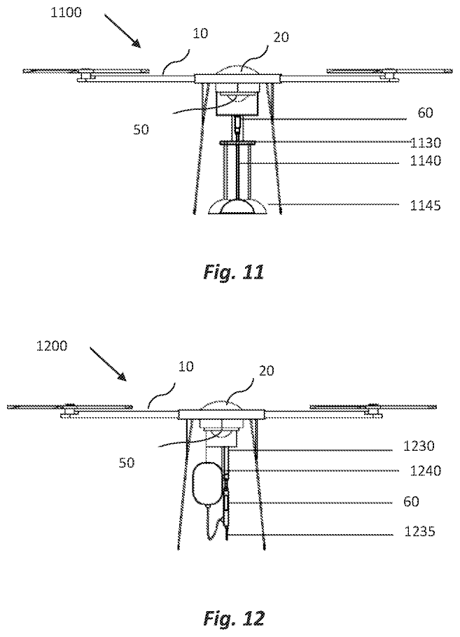

Reference is made to FIG. 11 which is an illustration of a hovering device for land marking according to some embodiments. Hovering device 1100 may include: hovering unit 10, position detector 20, controller 50 and camera 60, as discloses herein above with respect to hovering device 100. In some embodiments, hovering device 1100 may further include at least one marker application unit 1130, and at least one markers container 1140. Marker application unit 1130 may include a piston (e.g., hydraulic/pneumatic, etc.) configured to dispatch pegs 1145 having a gluing unit configured to be glued to the location, upon hitting the ground at the location.

In some embodiments, the marking may be done by a marker, such as paint, glue, epoxy, a laser point and the like. The marker may include a permanent/semi-permanent or temporary (e.g., laser point) mark at the location. Reference is now made to FIG. 12 which is an illustration of a hovering device for land marking according to some embodiments of the invention. Hovering device 1200 may include: hovering unit 10, position detector 20, controller 50 and camera 60, as discloses herein above with respect to hovering device 100. In some embodiments, hovering device 1200 may further include at least one marker application unit 1230 for applying a marker and at least one markers container 1240. Marker container 1240 may include a tank for carrying material to be sprayed/printed/deposited/applied by marker application unit 1230 and the like on the surface of the ground at the location. Marker application unit 1230 may further include an injection/application pipe and a nozzle for spraying/printing/depositing/applying the material. In some embodiments, marker application unit may be configured to deposit/print or stick a code such as: QR code, bar-code and the like, on the surface of the land in the location. In some embodiments, sticker with codes can be dispatch from the air wile hovering device 10 hovers over the location. In some embodiments, a printer code may be printed in the location by, for example, an ink-jet a printer included in marker application unit 1230 after hovering device has landed at or near the location. In some embodiments, the marking material may include any flowing medium that may leave a mark at the location, for example, an ink, a glue, an epoxy and the like.

In some embodiments, at least one marker application unit 1230 may be a laser pointer configured to mark the location with a laser point. In such case; container 1240 may be a battery for providing electricity to the laser pointer.

Some additional aspects of the invention may be directed to a system of two or more hovering devices operable together in order to accurately mark a location. For example, a first hovering device may mark the location with a marker that is semi-permanent or temporary, the first hovering device may be lighter in weight (e.g., 6 Kg.) and may navigate more easily than a second hovering device. The second hovering device (e.g., weighing 60 Kg.) may be configured to apply a rigid three-dimensional marker at the location previously marked by the first hovering device. In some embodiments, the first hovering device (e.g., the lighter device) may have a better aerodynamics, and better resistance to wind and turbulence. Accordingly, the first hovering device may be more stable (e.g., have a movement of less than 5 cm in each direction while hovering above the location) may be configured to hold its accurate position for longer period of time in comparison to the second hovering device.

In some embodiments, the first hovering device may include a first hovering unit; a position detector and first marker application unit for applying a first marker. The first hovering device may be, for example, device 1200 illustrated in FIG. 12 or any other suitable hovering device. In some embodiments, the first marker application unit may be at least one of: a laser pointer, a spraying device and a color painter. The second hovering device may include: a second hovering unit; at least one second marker application unit carried by the second hovering unit and at least one markers container, carried by the second hovering unit, for feeding one or more markers to the at least one second markers application unit. In some embodiments, second hovering device may be any one of devices 100-1100 discussed herein above. In some embodiments, the second hovering device may include a detector (e.g.; position detector 20) for detecting a first marker (e.g., a laser point/a print/a two-dimensional mark) made by the first marker application unit (e.g., unit 1230) of the first hovering device (e.g., device 1200). For example; the detector may include a detector configured to detect a laser point, to recognize (e.g., using image recognition methods of images received for example, form camera 60) a mark on the location and the like.

In some embodiments, the system may further include at least one controller, for example, controllers 50 of hovering device 1200 and any one of controllers 50 of hovering devices 100-1100. In some embodiments; the controller may be configured to: receive a location in an area to be marked by a marker; direct the first hovering unit to hover over or near the location (e.g., in an angular deviation from the location, when marking with a laser pointer) based on information received from the position detector and control the first marker application unit to applying the first marker. When applying a paint/epoxy or ant other flowing medium as a marker, the first hovering unit may hover above the location, mark the location and then fly away from the location. When marking with a laser pointer, the first hovering unit may hover near the location, point a laser to the location (e.g., in an angular deviation from the location) and remain near the location to allow the second hovering unit to home in on the laser point.

In some embodiments, once the first marker is being detected (e.g., recognized) by the controller, the controller may direct the second hovering unit to hover over the location based the first marker detected by the detector. In some embodiments, the second hovering device may home in on the first marker. In some embodiments, the controller may further be configured to: control the at least one second marker application unit to apply a second marker to a location marked by the first marking.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A hovering device for land marking, comprising:
a hovering unit;
a position detector attached to the hovering unit;
at least one marker application unit carried by the hovering unit;
at least one markers container, carried by the hovering unit, for feeding one or more markers to the at least one marker application unit; and
a controller configured to:
receive a location in an area to be marked by a marker;
direct the hovering unit to hover over the location based on information received from the position detector; and
control the at least one marker application unit to apply a marker to the location.

2. The hovering device of claim 1, wherein the at least one marker application unit comprises dispatching mechanism for dispatching markers from the position of hovering device in the air towards the location in the area.

3. The hovering device of claim 1, wherein the at least one marker application unit comprises a screwing device configured to screw a marker to the location while the hovering device hovers above the location.

4. The hovering device of claim 1, wherein the controller is configured to land the hovering device at the location and control the marker application unit to mark the location thereafter.

5. The hovering device of claim 1, wherein the controller is configured to control the at least one marker application unit to apply the marker at a deviation of no more than 10 cm from the location.

6. The hovering device of claim 1, wherein the one or more markers are selected from a group consisting of: arrows, screws, bolts, wedges, stakes, pegs, spits, pin, skewers, flags, nails, stickers, three-dimensional printed element and engraving.

7. The hovering device of claim 1, wherein the one or more marking units are selected from a group consisting of: a laser pointer, a spraying device, a color painter and a sticker.

8. The hovering device of claim 1, wherein the position detector is at least one of: a real time kinematics (RTK) detector with a GPS, based on a 3D model of the area, robotic total station, based on ground control points and based on beacons spread around the area.

9. The hovering device of claim 1, further comprising a camera attached to the hovering unit for capturing one or more images of at least a portion of the area.

10. The hovering device of claim 9, wherein the controller is further configured to:
receive an image of the area from the camera; and
control the at least one marker application unit to apply a marker to the location also based on data extracted from the received image.

11. A hovering system comprising:
a first hovering device comprising:
a first hovering unit;
a position detector; and
a first marker application unit for applying a first marker; and
a second hovering device comprising:
a second hovering unit;
at least one second marker application unit carried by the second hovering unit;
at least one markers container, carried by the second hovering unit, for feeding one or more markers to the at least one second markers application unit; and
a detector for detecting a first marker made by the first marker application unit of the first hovering device; and
at least one controller configured to:
receive a location in an area to be marked by a marker;
direct the first hovering unit to hover over the location based on information received from the positioning detector;
control the first marker application unit to applying the first marker;
direct the second hovering unit to hover over the location based the first marker detected by the detector; and
control the at least one second marker application unit to apply a second marker to the location marked by the first marking.
